(19) United States
(12) Patent Application Publication
(10) Pub. No.: US 2003/0084545 A1
(43) Pub. Date: May 8, 2003

(54) Lightweight cement trowel handle with preferred tightness and safe grip

(76) Inventor: Chun-Yong Cheng, Taipei (TW)

Correspondence Address: Chun-Yong Cheng, P. O. Box No. 6-57, Chung-Ho, Taipei, 235, TW

(21) Appl. No.: 09/985,226

(22) Filed: Nov. 2, 2001

(51) Int. Cl. B62B 1/00

(52) U.S. Cl. 16/430

(57) ABSTRACT

A lightweight cement trowel handle with preferred tightness and safe grip, comprises a handle interlocked by aligning two shell-shaped bottom seat and top cover through high frequency pressure and sheathed by a soft TPR material as the external layer; wherein, the bottom seat and the upper cover not only have reinforcing ribs disposed on the inner sides, but also have clamp frames with several double diameter holes disposed in the front aspect; a ring seat is disposed at the distal end of the bottom seat; an insert end of the said top cover is forced into an insert slot of the ring seat for mutual alignment and interlock; a blade piece is clamped between the clamp frames of the handle, penetrated by a screw and fastened by a nut; thereby the said hexagon nut is fitly received and fixed inside the double diameter hole of the top cover.

### BACKGROUND OF THE INVENTION

1) FIELD OF THE INVENTION

The present invention relates to a lightweight cement trowel handle with preferred tightness and safe grip, more specifically, a handle interlocked by two shell-shaped bottom seat and top cover, sealed by high frequency pressure and sheathed by a soft TPR material; the special innovative style of the structural design makes the handle a comfortable product not tending to scratch by the blade tool; furthermore, the special design of the screw fastening prevents the connection of the handle and the blade tool from loosening; that is the feature of the present invention.

2) DESCRIPTION OF THE PRIOR ART

Accordingly, the conventional cement trowel, as shown in FIG. 5, is disposed with a long handle (60) from plastic injection, the said handle (60) is engaged by aligning an upper and a lower die tools; therefore, when opening the die tools, thin injuring chips (63) are left at the area of connection; an insert slot (61) is horizontally disposed at one end of the handle (60); locking holes (62) penetrate longitudinally at the upper and the lower ends of the insert slot (61) at the end portion of the handle (60); a fastening hole (71) is disposed at the rear end of blade piece (70) of the trowel; the end side of the fastening hole (70) of the blade piece (70) is forced into the insert slot (61); the fastening hole (71) fits the locking hole (62); the locking hole (62) and the fastening hole (71) are penetrated respectively by screws (50) and fastened by a nut (51).

Unavoidably, a trowel is used to knock the bricks, however, the screw of the mentioned conventional structure tends to loosen after a long usage and that makes the blade piece (70) waver to influence the work; that is another shortcoming of the conventional structure.

Referring to FIG. 6, since the conventional structure does not have a good structural style, the user's hand may be scratched by the side rim in the rear aspect of the blade piece (70) to bleed; that is yet another shortcoming of the conventional structure; in addition, the mentioned plastic made grip has the problem of scratching the user's hand by the left chips (63) and that has always been the common shortcoming of the conventional structure.

Furthermore, the conventional structure may use a wooden grip with heavier weight; the wood has fibers which may injure the human hand; that is also one of the shortcomings of the conventional structure; in addition, the precision of drilling a screw hole is hard to control and that is counted as an additional shortcoming of the conventional structure.

### SUMMARY OF THE INVENTION

Therefore, the primary objective of the present invention is to have a handle interlocked by aligning two shell-shaped bottom seat and top cover through high frequency pressure and sheathed by a soft TPR material as the external layer; wherein, the bottom seat and the upper cover not only have reinforcing ribs disposed on the inner sides, but also have clamp frames with several double diameter holes disposed in the front aspect; a penetrating holes is disposed at a proper position in the rear aspect of the bottom seat; a ring seat with an insert slot at the center is disposed at the distal end of the bottom seat; a support post is disposed on the top cover to correspond to the penetrating hole of the bottom seat; the rear end of the top cover is defined as an insert end; wherein, the shape of the double diameter hole of the top cover is a hexagon; the insert end of the said top cover is forced into an insert slot of the ring seat for mutual alignment, interlock and making the support post fit into the penetrating hole area; a blade piece is clamped between the clamp frames of the handle, penetrated by a screw and fastened by a nut; thereby the said hexagon nut is fitly received and fixed inside the double diameter hole of the top cover.

To enable a further understanding of the present invention, a brief description of the drawings below is followed by the detailed description of the preferred embodiment.

### BRIEF DESCRIPTION OF THE DRAWINGS

FIG. 1 is an exploded and inside-out structural drawing of the handle of the present invention.

FIG. 2 is an exploded drawing of the longitudinal and sectional structure of the top cover and the bottom seat of the present invention.

FIG. 3 is an assembled drawing of the longitudinal and sectional structure of the top cover and the bottom seat of the present invention.

FIG. 4 is an external view drawing of the assembled top cover and bottom seat of the present invention.

FIG. 5 is a structural drawing of a conventional plastic handle.

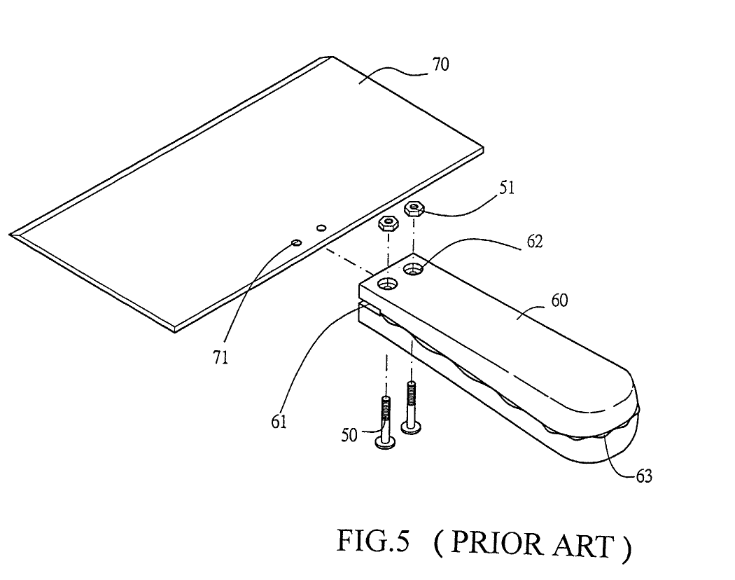

FIG. 6 is a drawing of a conventional application.

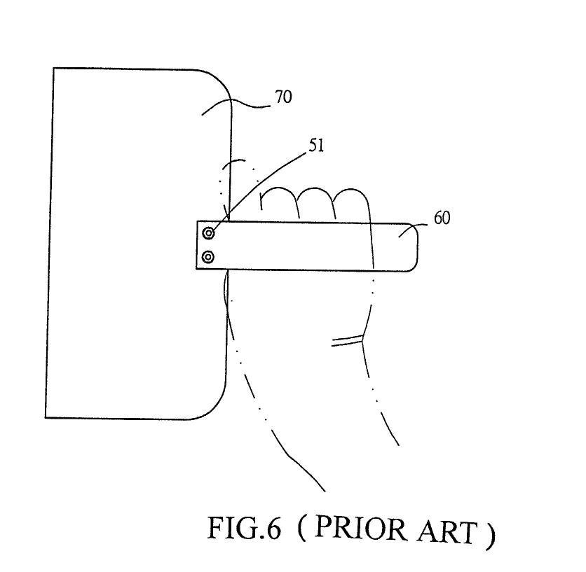

### DETAILED DESCRIPTION OF THE PREFERRED EMBODIMENTS

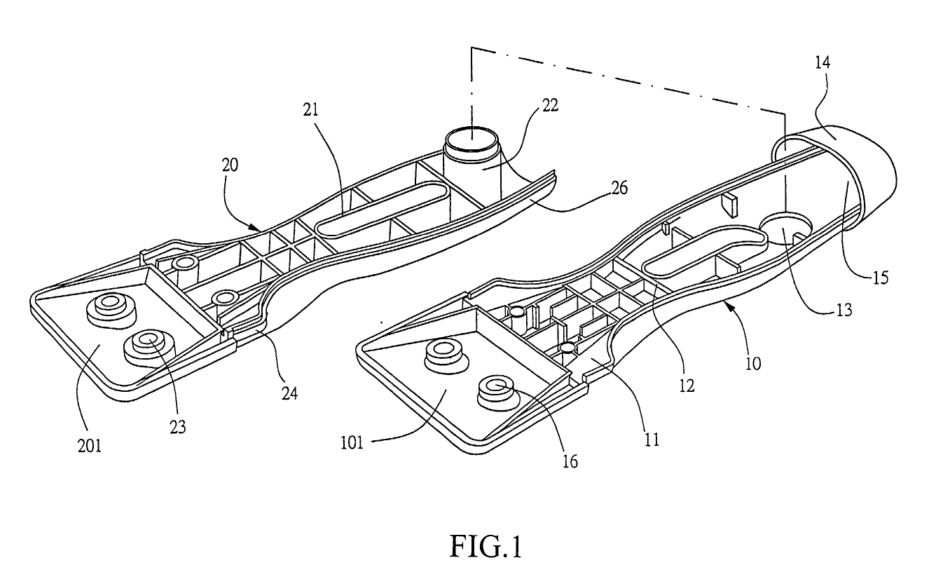

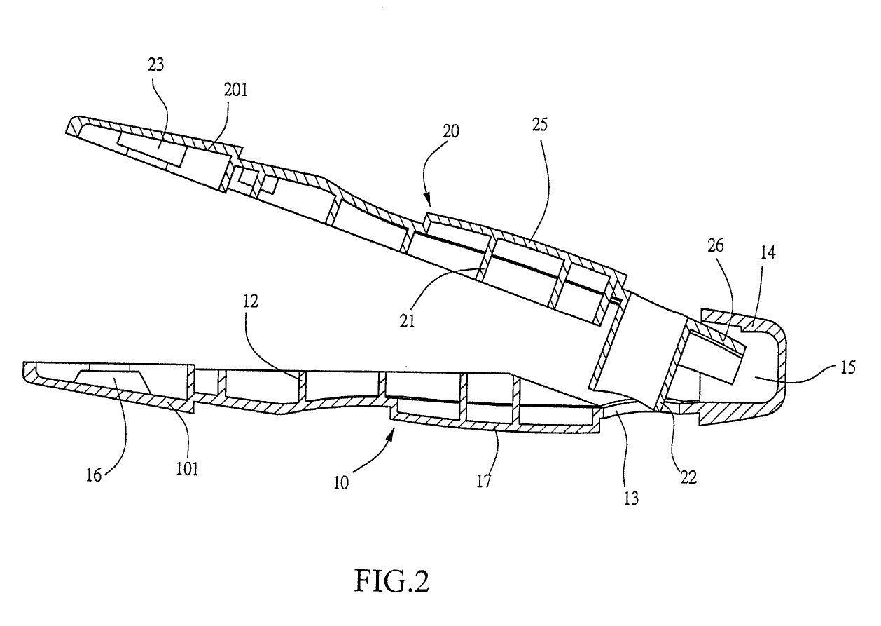

Referring to FIGS. 1 and 2, a handle of the present invention is interlocked by aligning two shell-shaped bottom seat (10) and top cover (20) through high frequency pressure and sheathed by a soft TPR material as the external layer; wherein, the bottom seat (10) is defined as a ergonomic and shell-shaped handle style, not only has reinforcing ribs (12) disposed on the inner sides, but also has a clamp frame (101) with several double diameter holes (16) disposed in the front aspect; the rear side of the clamp frame (101) protrudes to form a lateral wing (11); a penetrating holes (13) is disposed at a proper position in the rear aspect of the bottom seat (10); the end portion of the bottom seat (10) protrudes in a certain thickness to have a ring seat (14) disposed thereat; an insert slot (15) is formed on the ring seat (14) opposite the relative side of the shell body of the bottom seat (10); several convex ribs (17) are disposed on the rear plane of the bottom seat (10).

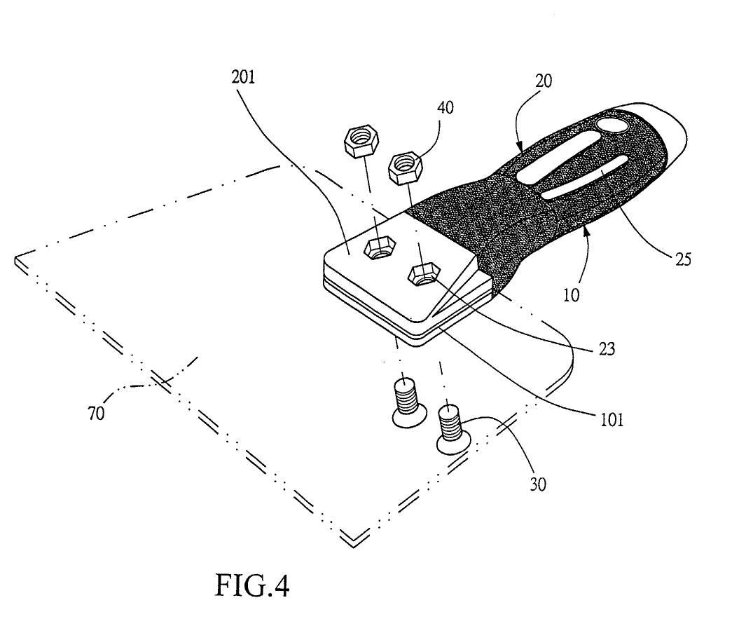

Referring to FIGS. 1, 2 and 4, the top cover (20) is the other half side relative to the shell-shaped handle of the bottom seat (10) and has reinforcing ribs (21) on the inner side and a convex rib (25) on the rear side; a clamp frame (201) with several double diameter holes (23) is disposed in the front aspect; a protruding lateral wing (24) is disposed in the rear aspect of the clamp frame (201); a support post (22) with a proper diameter is disposed relatively at the penetrating hole (13) area of the bottom seat (10); the rear aspect of the top cover (20) is directly formed as an insert end (26); referring to FIG. 4, the shape of the larger diameter of the double diameter hole (23) of the top cover (20)is hexagon.

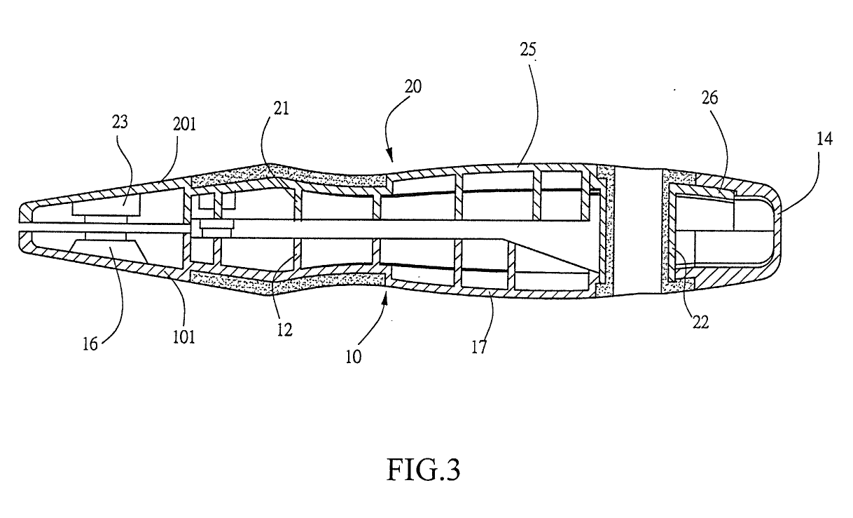

Referring to FIGS. 2 and 3, the insert end (26) of the top cover (20) is forced into the insert slot (15) of the ring seat (14); the top cover (20) and the bottom seat (10) align to interlock and are sealed through high frequency on the circumferential sides thereof; the support post (22) fits at the penetrating hole (13) area to make the handle have certain strength, as shown in FIGS. 3 and 4, after the connection, on the handle, the concave area between the ring seat (14) on the surface plane and the convex ribs (17, 25) is sheathed by a layer of TPR material as the surface layer for comfortable grip; a blade piece (70) is clamped between the clamp frames (101, 201) of the handle, penetrated by a screw (30) and fastened by a nut (40); at this time, the said hexagon nut (40) is fitly received and fixed inside the double diameter hole (23) of the top cover (20) to prevent the screw (30) from loosening.

The special innovation of the present invention has the following advantages in application:

1. The primary advantage of the present invention is that the top cover and the bottom seat are in the forms of shell-shapes, interlocked and sealed through high frequency as well as sheathed by a TPR material to make a very comfortable grip; in addition, both of the inner sides are disposed with reinforcing ribs to fit the insertion between the support post and the penetrating hole so as to have an extremely good strength on itself.

2. Another advantage of the present invention is that lateral wings sheathed in a soft TPR material are disposed on two sides in the front aspect and that allows the human fingers to press against that area when grabbing the trowel handle without being scratched by the blade piece but to have a very comfortable grip.

3. Yet another advantage of the present invention is that the interlock of the die tools makes the drilling processing even more delicate; furthermore, since the top cover and the bottom seat are in the shapes of shells, the heat dissipation of the heat molding is fast and the processing can be quicker.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A lightweight cement trowel handle with preferred tightness and safe grip, a handle comprises two shell-shaped bottom seat and top cover aligned and interlocked through high frequency pressure as well as sheathed by a soft TPR material as the external layer; wherein, the bottom seat and the upper cover not only have reinforcing ribs disposed on the inner sides, but also have clamp frames with several double diameter holes disposed in the front aspect;
a penetrating holes is disposed at a proper position in the rear aspect of the bottom seat and a ring seat with an insert slot at the center is disposed at the end portion;
a support post is disposed relatively at the penetrating hole area of the bottom seat; the rear end of the top cover is formed as an insert end; the shape of the double diameter hole of the top cover is hexagon; the insert end of the top cover is forced into the insert slot of the ring seat for mutual alignment and interlock, thereby, to make the support post fit into the penetrating hole area; a blade piece is clamped between the clamp frames of the handle, penetrated by the screws and fastened by the nuts; at this time, the said hexagon nut is fitly received and fixed inside the double diameter hole of the top cover.

2. A lightweight cement trowel handle with preferred tightness and safe grip according to claim 1, wherein, protruding lateral wings are formed where the top cover and the bottom seat relative to the rear sides of the clamp frame for preventing scratching from the blade piece.

3. A lightweight cement trowel handle with preferred tightness and safe grip according to claim 1, wherein, several ribs are disposed on the rear plane of the bottom seat and the top cover.
